(19) United States
(12) Patent Application Publication
(10) Pub. No.: US 2013/0194529 A1
(43) Pub. Date: Aug. 1, 2013

(54) BACKLIGHT MODULE AND DISPLAY DEVICE INCLUDING THE SAME

(71) Applicants: INNOCOM TECHNOLOGY(SHENZHEN) CO., LTD, Longhua Town (CN); CHIMEI INNOLUX CORPORATION, Miao-Li County (TW)

(72) Inventors: Hsuan-Wei CHANG, Miao-Li County (TW); Shih- Chang HUANG, Miao-Li County (TW); Jeng-Wei YEH, Miao-Li County (TW)

(73) Assignees: CHIMEI INNOLUX CORPORATION, Miao-Li County (TW); INNOCOM TECHNOLOGY(SHENZHEN) CO., LTD., Longhua Town (CN)

(21) Appl. No.: 13/693,742

(22) Filed: Dec. 4, 2012

(30) Foreign Application Priority Data
Jan. 30, 2012 (TW) 101102780

(51) Int. Cl. G02F 1/1335; G09F 13/04

(52) U.S. Cl. CPC G02F 1/133608; G09F 13/0413
USPC 349/58; 362/97.1

(57) ABSTRACT

A backlight module is provided, which includes a base, a light source, and at least one polygonal support member. The base has a lower surface, and the light source is disposed on the base. A transverse section of the polygonal support member includes a first side, and an angle formed by a projection line of a connecting line between the midpoint of the first side and the light source on the lower surface and a projection line of the first side on the lower surface is between 80 degrees and 100 degrees.

### CROSS REFERENCE TO RELATED APPLICATIONS

This Application claims priority of Taiwan Patent Application No.101102780, filed on Jan. 30, 2012, the entirety of which is incorporated by reference herein.

### BACKGROUND OF THE INVENTION

1. Field of the Invention

The present invention relates to a backlight module, and in particular relates to a backlight module with a support member.

2. Description of the Related Art

With the rapid development of advanced technologies, liquid crystal displays (LCDs) have the advantages of being thin in size, economical with electricity, and do not emit radiation. They are routinely applied to various electrical products such as tablet computers, notebooks, digital cameras, digital video recorders, cellular phones, computer displays and LCD TVs, and so on. Because display panels in LCDs are non-emissive, it is necessary to use backlight modules as a light source.

A large LCD generally requires the installation of several support members in between the backlight module and the LC panel, or in between the backlight module and the optical plate, such as a diffusing plate, to keep a uniform distance. For high-contrast LCDs, where LEDs are controlled independently, a shadow effect may arise on the panel area around the support member as a result of random light refraction and reflection due to the non-uniform luminance of LEDs surrounding the support member as well as the shade of the support member itself. In addition, the concentrated brightness of the optical plate can also account for undesirable noises.

FIG. 1 shows a schematic view of partial elements of a conventional backlight module. A backlight module 50 includes a support member 51, and a plurality of light sources 52. As shown in FIG. 1, due to the relative positions of the support member 51 and the light sources 52 around the support member 51, or due to the non-uniform luminance of light sources 52 around the support member 51, a shadow noise is produced near the support member 51, which in turn reduces the quality of the image displayed near the support member 51.

In view of this, there is a need to provide a method to eliminate the shadow around the support member of the backlight module of an LCD so as to ensure overall image quality.

### BRIEF SUMMARY OF THE INVENTION

In this regard, one of the objectives of the present disclosure is to provide a method to eliminate the shadow around the support member of a backlight module.

To achieve the above objective, the present disclosure provides a backlight module which includes a base, a light source, and at least one polygonal support member. The base has a lower surface, and the light source is disposed on the base. A transverse section of the polygonal support member includes a first side, and an angle formed by a projection line of a connecting line between the midpoint of the first side and the light source on the lower surface and a projection line of the first side on the lower surface is between 80 degrees and 100 degrees.

The present disclosure further provides a display device including the above backlight module, wherein a display panel is disposed on the backlight module, and the optical film disposed between the backlight module and the display panel is supported by the polygonal support member.

Through the structural feature of the lateral sides of the support member, light from the light source passes through the support member without hindrance. Since enough luminance is provided at the side of the support member opposite the light source, the uneven brightness issue on the panel area due to shadow noises can be resolved.

### BRIEF DESCRIPTION OF THE DRAWINGS

The present invention is more fully understood by reading the subsequent detailed description and examples with references made to the accompanying drawings, wherein:

FIG. 1 is a schematic view of elements of a typical backlight module;

FIG. 2 is a cross-sectional view of a display device in accordance with the preferred embodiment of the present disclosure;

FIG. 3 is a partial schematic view of elements of a backlight module in accordance with the first embodiment of the present disclosure;

FIG. 4 is a cross-sectional view taken along line a-a in FIG. 3, as seen from the extending direction V;

FIG. 5 is a schematic view of a support member in accordance with the first embodiment of the present disclosure;

FIG. 6 is a schematic view of another support member in accordance with the first embodiment of the present disclosure;

FIG. 7 is a schematic view of elements of a backlight module in accordance with a second embodiment of the present disclosure;

FIG. 8 is a cross-sectional view taken along line b-b in FIG. 7, as seen from the extending direction V.

FIG. 9 is a schematic view of elements of a backlight module in accordance with a third embodiment of the present disclosure;

FIG. 10 is a cross-sectional view taken along line c-c in FIG. 9, as seen from the extending direction V;

FIG. 11 is a schematic view of a support member in accordance with the third embodiment of the present disclosure;

FIG. 12 is a schematic view of another support member in accordance with the third embodiment of the present disclosure;

FIG. 13 is a schematic view of elements of a backlight module in accordance with a fourth embodiment of the present disclosure;

FIG. 14 is a cross-sectional view taken along line d-d in FIG. 13, as seen from the extending direction V; and

FIG. 15 is a curve diagram showing variation in the intensity of fluorescent energy of a third light source in a region S in FIG. 14 with respect to an increased distance in direction X.

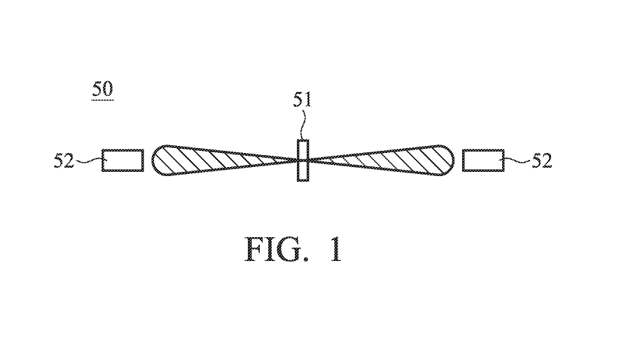

### DETAILED DESCRIPTION OF THE INVENTION

The following description is of the best-contemplated mode of carrying out the invention. This description is made for the purpose of illustrating the general principles of the invention and should not be taken in a limiting sense. The scope of the invention is best determined by reference to the appended claims.

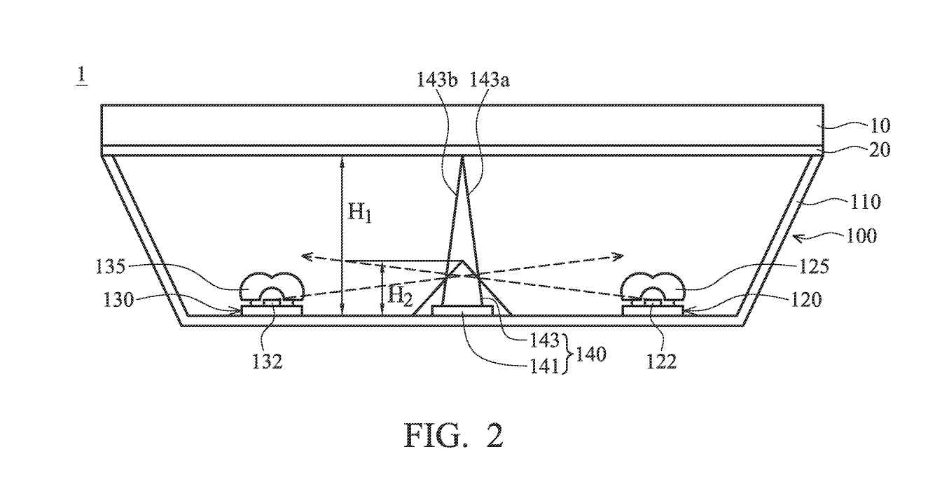

FIG. 2 shows a display device 1 in accordance with the preferred embodiment of the present disclosure. The display device 1 includes a display panel 10, an optical film 20, and a backlight module 100. The display panel 10 is disposed above the backlight module 100, and the optical film 20 is disposed between the display panel 10 and the backlight module 100. The backlight module 100 includes a substrate 110, a first light bar 120, a second light bar 130, at least one polygonal support member 140, and a plurality of partitions 150, wherein the optical film 20 is disposed on the polygonal support member 140.

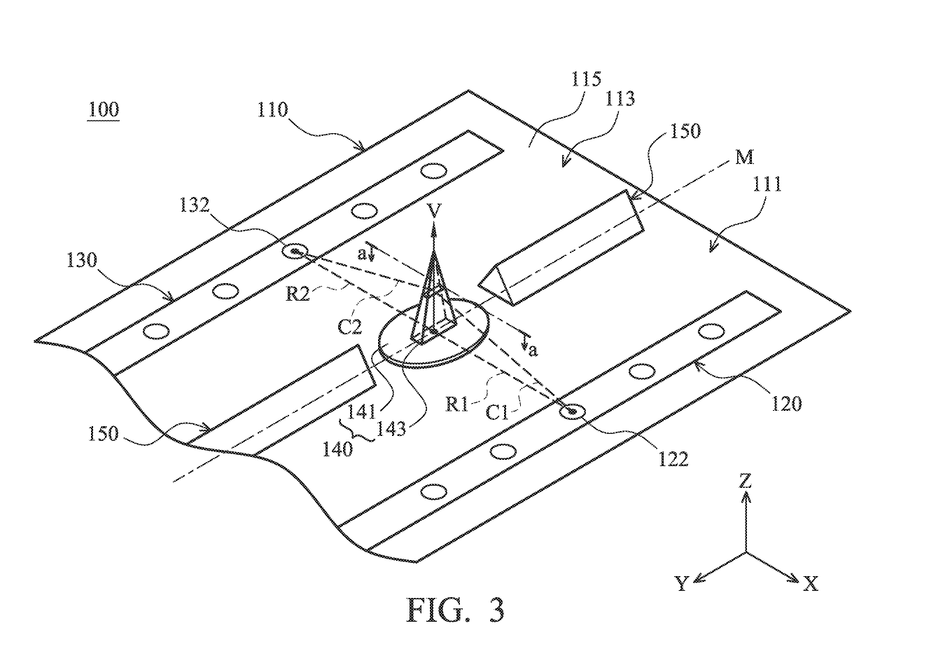

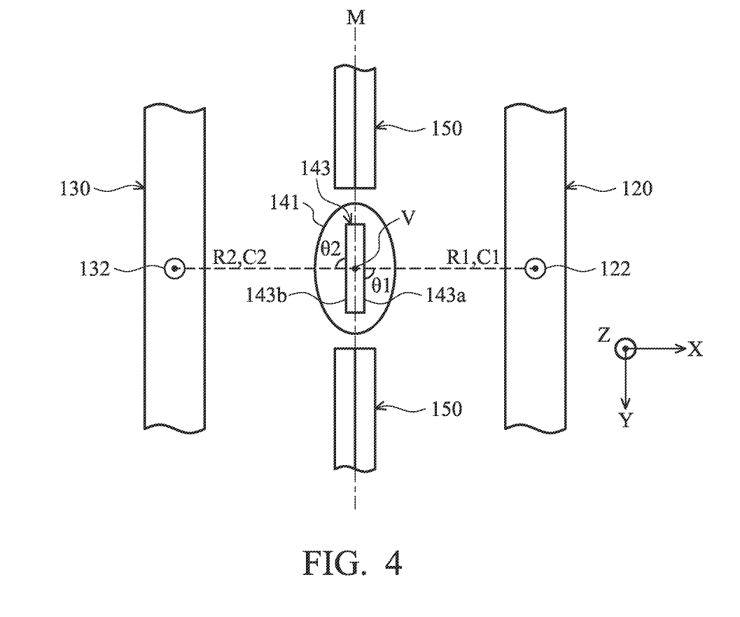

FIG. 3 shows a partial schematic view of elements of the backlight module 100 in accordance with the first embodiment of the present disclosure, and FIG. 4 shows a cross-sectional view taken along line a-a in FIG. 3, as seen from the extending direction V. The substrate 110 includes a lower surface 115, wherein a first region 111 and a second region 113 are divided by a dividing line M. The first and second light bars 120 and 130 are respectively disposed in the first region 111 and the second region 113 of the substrate 110. The first light bar 120 includes a plurality of first light sources 122 arranged thereon, and a plurality of optical lenses 125 (FIG. 2) are disposed upon each of the light sources 122 configured to diffuse light therefrom. The second light bar 130 includes a plurality of second light sources 132 disposed thereon, and a plurality of optical lenses 135 (FIG. 2) are disposed upon each of the light sources 132 configured to diffuse light of the second light sources 132. The first light sources 122 and the second light sources 132 may consist of point light sources.

The polygonal support member 140 is fabricated of a light-transmitting material. In one exemplary embodiment, the polygonal support member 140 is made of PMMA material, but it is not limited thereto. Any light-transmitting material can be applied as the polygonal support member 140 of the present disclosure. The polygonal support member 140 includes a base 141 and a main body 143. The bottom surface of the base 141 is located on a connecting line between the first light source 122 and the second light source 132 and is located on the dividing line M, wherein the dividing line M is centered between the first and second light bars 120 and 130, as shown in FIG. 4. That is, the base 141 is located at the symmetrical center of the first light source 122 and the second light source 132, but it should not be limited thereto. In another embodiment, the base 141 is located on the dividing line M, wherein the distance of the dividing line M and the first light bar 120 is different from the distance of the dividing line M and the second light bar 130, and at least a portion of the bottom surface of the base 141 is located on the connecting line between the first light source 122 and the second light source 132, as shown in FIG. 4.

The main body 143 is disposed on the base 141 and has a first height H₁ extending along the direction V away from the substrate 110, wherein along the direction V, the area of transverse sections of the polygonal support member 140 decreases gradually, and the distance between the optical film 20 and the substrate 110 is equal to the first height H₁, as shown in FIG. 2. In the embodiment, the bottom surface of the base 141 of the polygonal support member 140 and the connecting line between the first light source 122 on the first light bar 120 and the second light source 132 on the second light bar 130 overlap.

As shown in FIG. 4, the main body 143 has a first side 143a and a second side 143b on one of its transverse sections, wherein the transverse sections are parallel to the lower surface 115. The first side 143a is at the lateral surface which is most adjacent to the first light source 122. An angle θ1 formed by a projection line R1 of a connecting line C1 between the midpoint of the first side 143a and the first light source 122 and a projection line of the first side 143a on the lower surface 115 is between 80 degrees and 100 degrees. The second side 143b is at the lateral surface which is most adjacent to the second light source 132. An angle θ2 formed by a projection line R2 of a connecting line C2 between the midpoint of the second side 143b and the second light source 132 and a projection line of the second side 143b on the lower surface 115 is between 80 degrees and 100 degrees.

By adjusting the light incident angle of the light from the first light source 122 projecting into the first side 143a of the polygonal support member 140, the light-emitting angle on the second side 143b is controlled, thereby decreasing the possibility that light will be completely reflected on the second side 143b. Similarly, the possibility that light from the second light source 132 will be completely reflected on the first side 143a is decreased. Therefore, the shadow noise produced around the polygonal support member 140 can be eliminated. It is noted that, while the angles θ1 and θ2 are between 80 degrees and 100 degrees, it should not be limited thereto. The angles θ1 and θ2 can be any angle that is able to prevent light from being completely reflected on the light-emitting surface of the polygonal support member 140. With the angles θ1 and θ2 being substantially formed at or near to a right angle (90 degrees), the possibility of total reflection is decreased. Preferably, the angles θ1 and θ2 are between 85 degrees and 95 degrees.

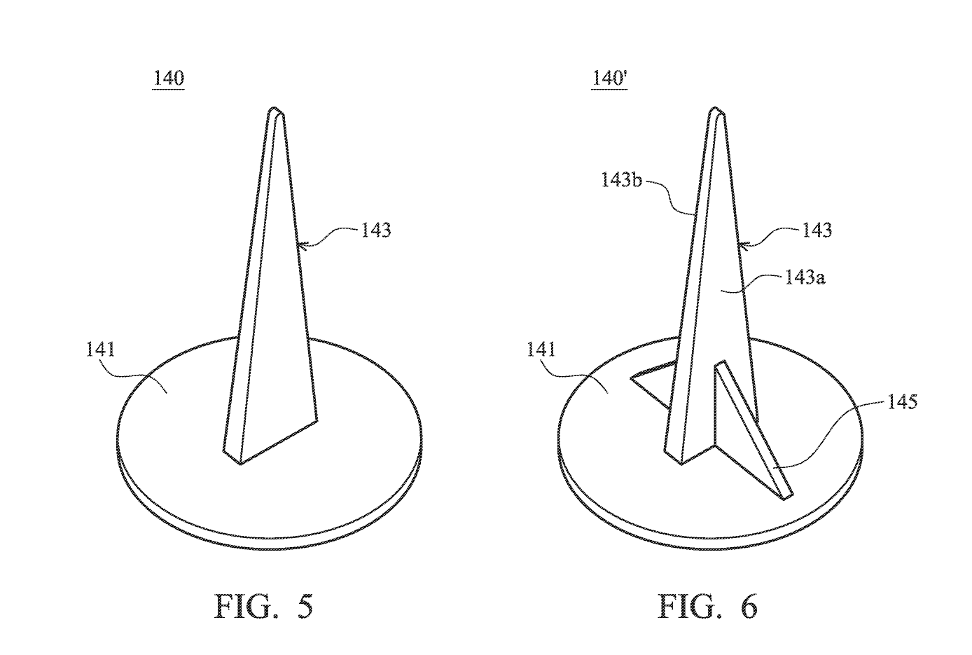

Referring to FIGS. 5 and 6, to increase the mechanical strength of the polygonal support member 140 in order to support the optical film 20, a plurality of reinforcing structures 145 may be connected between the base 141 and the main body 143, as shown in FIG. 6. In one exemplary embodiment, two reinforcing structures 145 with triangular shape are connected between the main body 143 and the base 141.

As shown in FIG. 2, with the arrangement of the optical lenses 125 and 135, light provided by the first light bar 120 and the second light bar 130 has a larger viewing angle; however, uneven brightness may occur at the light-emitting surface of the display device. To solve this problem, a partition 150 is disposed between the first light bar 120 and the second light bar 130. Specifically, referring again to FIG. 3, the partition 150 is disposed on the substrate 110 along the dividing line M, wherein the polygonal support member 140 is located between the two partitions 150. In the embodiment, the transverse section of the partition 150 has a triangular shape, and the partition 150 has a second height H₂ (FIG. 2) extending along the direction V away from the substrate 110, wherein the second height H₂ is less than half height of the first height H₁ (FIG. 2). That is, the second height H₂ is less than half the distance between the optical film 20 and the substrate 110. Due to the arrangement of the partition 150, the shape of the light emerging from the backlight module can be adjusted so that the uneven brightness can be eliminated, and the image display quality of the display device is improved.

The backlight module applied in the display device 1 is not limited by the above embodiment. In the description below, some exemplary implementation methods of the backlight module will be illustrated.

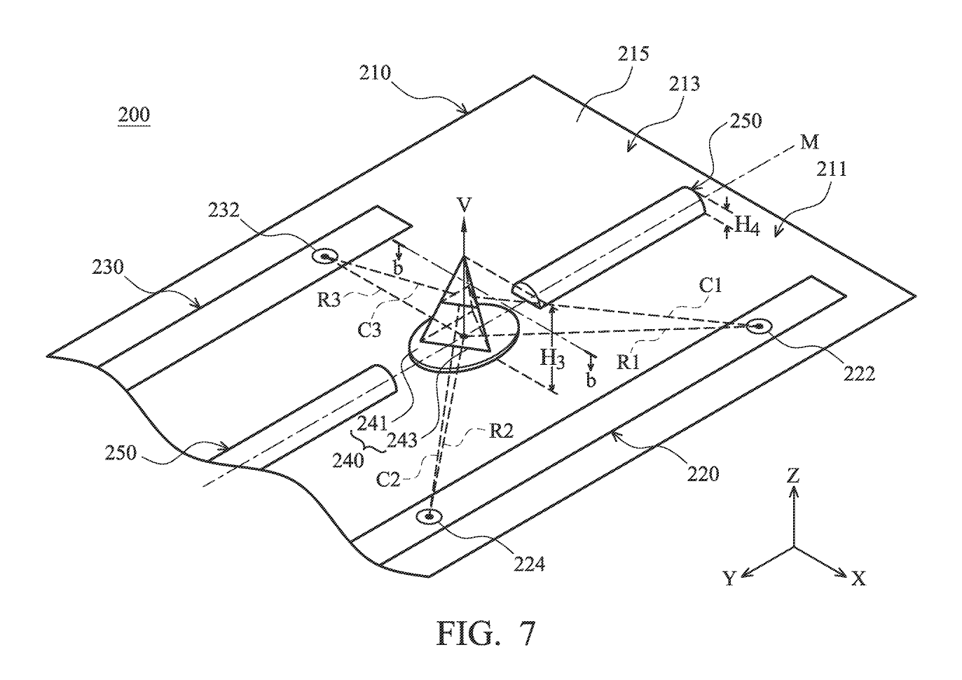

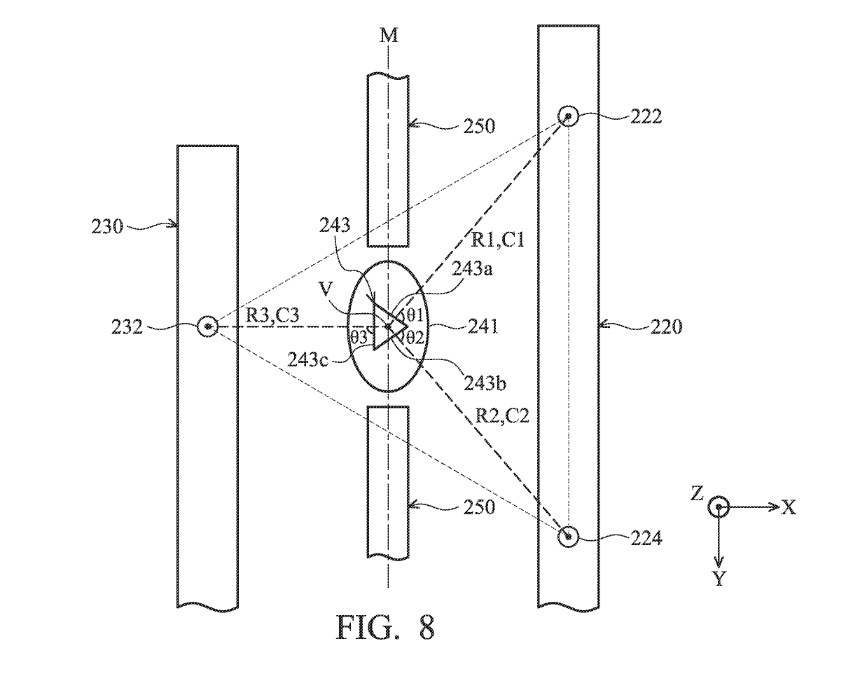

FIG. 7 shows a schematic view of partial elements of the backlight module 200 in accordance with a second embodiment of the present disclosure, and FIG. 8 shows a cross-sectional view taken along line b-b in FIG. 7, as seen from the extending direction V. The backlight module 200 includes a substrate 210, a first light bar 220, a second light bar 230, at least one polygonal support member 240, and a plurality of partitions 250. The substrate 210 includes a lower surface 215, wherein a first region 211 and a second region 213 of the substrate 210 are divided by a dividing line M. The first and second light bars 220 and 230 are respectively disposed in the first region 211 and the second region 213 of the substrate 210. The first light bar 220 includes a first light source 222 and a second light source 224 arranged thereon, and the second light bar 230 includes a third light source 232 disposed thereon. The first light source 222, the second light source 224 and the third light source 232 may consist of point light sources.

The polygonal support member 240 is fabricated by a light-transmitting material. In one exemplary embodiment, the polygonal support member 240 is made of PMMA, but is not limited thereto. Any light-transmitting material can be applied as the polygonal support member 240 of the present disclosure. The polygonal support member 240 includes a base 241 and a main body 243. In the embodiment, the distances between the base 241 and each of the first light source 222, the second light source 224, and the third light source 232 are equal, and the base 241 is located on the dividing line M, wherein the distance of the dividing line M and the first light bar 220 is different from the distance of the dividing line M and second light bars 230. That is, the base 241 is located at the symmetrical center of the first light source 222, the second light source 224, and the third light source 232, but it should not be limited thereto. In another embodiment, the base 241 is located on the dividing line M, wherein the distance of the dividing line M and the first light bar 220 is different from the distance of the dividing line M and the second light bar 230, and at least a portion of the bottom surface of the base 241 (the surface connecting to the surface of the substrate 210) is located on a region surrounded by the connecting lines between three points which are relative to the first light source 222, the second light source 224, and the third light source 232, as shown in FIG. 8. The main body 243 is disposed on the base 241 and has a first height H₃ extending along the direction V away from the substrate 210, wherein along the direction V, the area of transverse sections of the polygonal support member 240 decreases gradually.

As shown in FIG. 8, the main body 243 has a first side 243a, a second side 243b, and a third side 243c on one of its transverse sections, wherein the transverse sections are parallel to the lower surface 215. The first side 243a is at the lateral surface which is most adjacent to the first light source 222. An angle θ1 formed by a projection line R1 of a connecting line C1 between the midpoint of the first side 243a and the first light source 222 and a projection line of the first side 243a on the lower surface 215 is between 80 degrees and 100 degrees. The second side 243b is at the lateral surface which is most adjacent to the second light source 224. An angle θ2 formed by a projection line R2 of a connecting line C2 between the midpoint of the second side 243b and the second light source 224 and a projection line of the second side 243b on the lower surface 215 is between 80 degrees and 100 degrees. The third side 243c is at the lateral surface which is most adjacent to the third light source 232. An angle θ3 formed by a projection line R3 of a connecting line C3 between the midpoint of the third side 243c and the third light source 232 and a projection line of the third side 243c on the lower surface 215 is between 80 degrees and 100 degrees.

Through the structural features of the main body 243, there is a reduced possibility that light from the first light source 222 will be completely reflected on the second side 243b or the third side 243c, or that light from the second light source 224 will be completely reflected on the first side 243a or the third side 243c, or that light from the third light source 232 will be completely reflected on the first side 243a or the second side 243b. Thus, the shadow noises produced around the polygonal support member 240 can be eliminated. It is noted that, while the angles θ1, θ2 and θ3 are between 80 degrees and 100 degrees, they should not be limited thereto. With the angles θ1, θ2 and θ3 being substantially formed at or near to a right angle (90 degrees), the possibility of total reflection is decreased. Preferably, the angles θ1, θ2 and θ3 are between 85 degrees and 95 degrees, while other angles may be implemented to prevent light from being completely reflected on the light-emitting surface of the polygonal support member 240.

Referring again to FIG. 7, the partition 250 is disposed on the substrate 210 along the dividing line M, wherein the polygonal support member 240 is located between the two partitions 250. In the embodiment, the transverse section of the partition 250 has semi-elliptically shape, and the partition 250 has a second height H₄ extending along the direction V away from the substrate 210, wherein the second height H₄ is less than half the first height H₃.

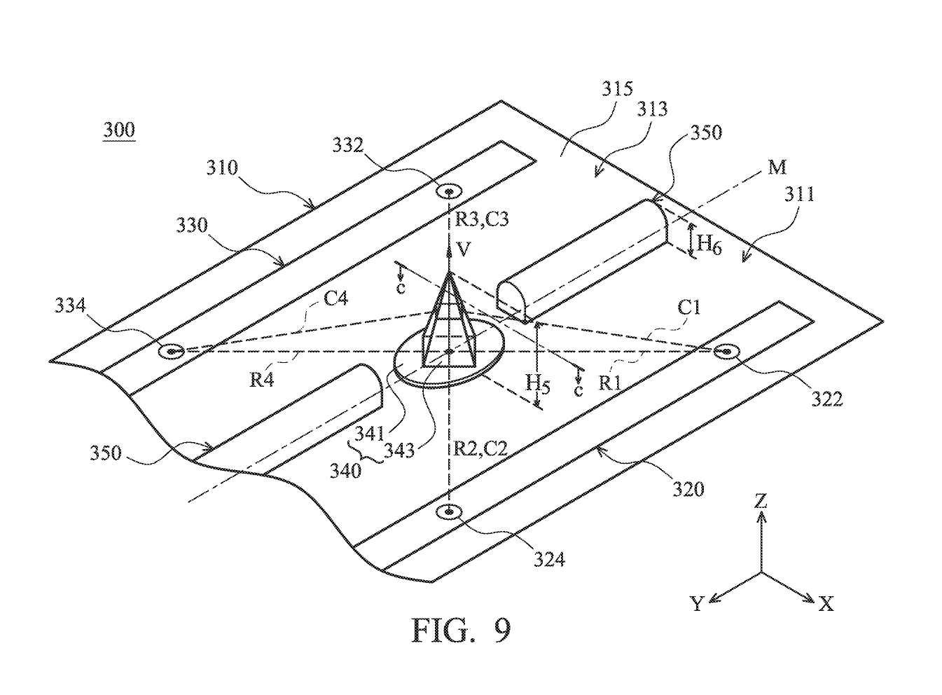

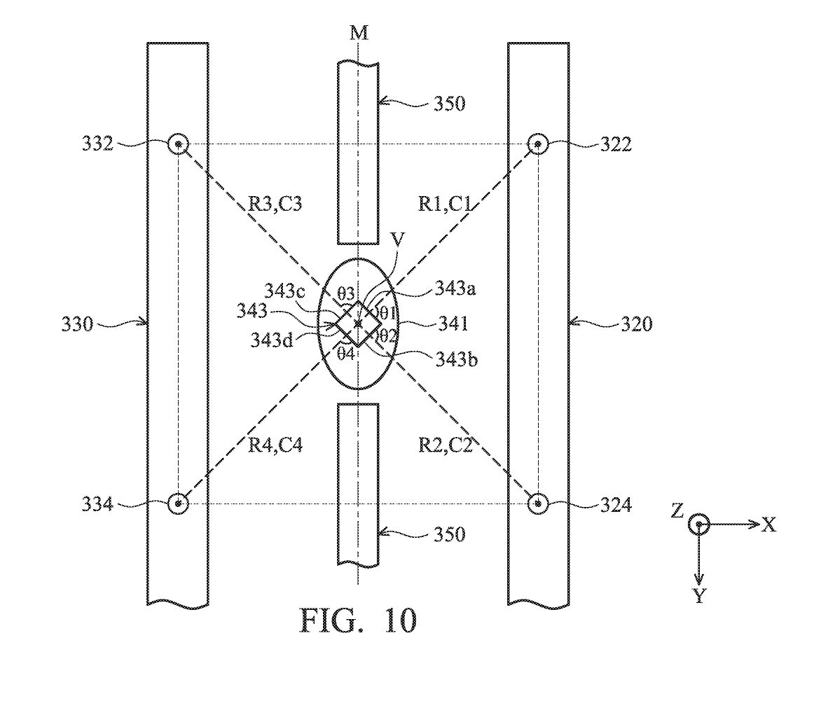

FIG. 9 shows a schematic view of elements of the backlight module 300 in accordance with a third embodiment of the present disclosure, and FIG. 10 shows a cross-sectional view taken along line c-c in FIG. 9, as seen from the extending direction V. The backlight module 300 includes a substrate 310, a first light bar 320, a second light bar 330, at least one polygonal support member 340, and a plurality of partitions 350. The substrate 310 includes a lower surface 315, wherein a first region 311 and a second region 312 of the substrate 310 are divided by a dividing line M. The first and second light bars 320 and 330 are respectively disposed in the first region 311 and the second region 312 of the substrate 310. The first light bar 320 includes a first light source 322 and a second light source 324 arranged thereon, and the second light bar 330 includes a third light source 332 and a fourth light source 334 disposed thereon. The first light source 322, the second light source 324, the third light source 332, and the fourth light source 334 may consist of point light sources.

The polygonal support member 340 is fabricated by a light-transmitting material. In one exemplary embodiment, the polygonal support member 340 is made of PMMA, but is not limited thereto. Any light-transmitting-material can be applied as the polygonal support member 340 of the present disclosure. The polygonal support member 340 includes a base 341 and a main body 343. In the embodiment, the distances between the base 341 and each of the first light source 322, the second light source 324, the third light source 332, and the fourth light source 334 are equal, and the base 341 is located on the dividing line M, wherein the dividing line M is centered between the first and second light bars 320 and 330. That is, the base 341 is located at the symmetrical center of the first light source 322, the second light source 324, the third light source 332, and the fourth light source 334, but it should not be limited thereto. In another embodiment, the base 341 is located on the dividing line M, wherein the distance of the dividing line M and the first light bar 320 is different from the distance of the dividing line M and the second light bar 330, and at least a portion of the bottom surface of the base 341 (the surface connecting to the surface of the base 310) is located in a region surrounded by the connecting lines between four points which are respectively relative to the first light source 322, the second light source 324, the third light source 332, and the fourth light source 334, as shown in FIG. 10. The main body 343 is disposed on the base 341 and has a first height H₅ extending along the direction V away from the substrate 310, wherein along the direction V, the area of transverse sections of the polygonal support member 340 decreases gradually.

As shown in FIG. 10, the main body 343 has a first side 343a, a second side 343b, a third side 343c, and a fourth side 343d on its transverse section, wherein the transverse section is parallel to the lower surface 315. The first side 343a is at one of the lateral surfaces which is most adjacent to the first light source 322. An angle θ1 formed by a projection line R1 of a connecting line C1 between the midpoint of the first side 343a and the first light source 322 and a projection line of the first side 343a on the lower surface 315 is between 80 degrees and 100 degrees. The second side 343b is at one of the lateral surfaces which is most adjacent to the second light source 324. An angle θ2 formed by a projection line R2 of a connecting line C2 between the midpoint of the second side 343b and the second light source 324 and a projection line of the second side 343b on the lower surface 315 is between 80 degrees and 100 degrees. The third side 343c is at one of the lateral surfaces which is most adjacent to the third light source 332. An angle θ3 formed by a projection line R3 of a connecting line C3 between the midpoint of the third side 343c and the third light source 332 and a projection line of the third side 343c on the lower surface 315 is between 80 degrees and 100 degrees. The fourth side 343d is at one of the lateral surfaces which is most adjacent to the fourth light source 334. An angle θ4 formed by a projection line R4 of a connecting line C4 between the midpoint of the fourth side 343d and the fourth light source 334 and a projection line of the fourth side 343d on the lower surface 315 is between 80 degrees and 100 degrees.

With the structural features of the main body 343, light from the first light source 322, the second light source 324, the third light source 332, and the fourth light source 334 that may be complete reflected by the first side 343a, the second side 343b, the third side 343c, or the fourth side 343d of the main body 343 is further reduced. Thus, the shadow noises produced around the polygonal support member 340 can be eliminated. It is noted that, while the angles θ1, θ2, θ3 and θ4 are between 80 degrees and 100 degrees, they should not be limited thereto. With the angles θ1, θ2, θ3 and θ4 being substantially formed at or near to a right angle, the possibility of total reflection is decreased. Preferably, the angles θ1, θ2, θ3 and θ4 are between 85 degrees and 95 degrees, while other angles may be implemented to prevent light from being totally reflected on the light-emitting surface of the polygonal support member 340.

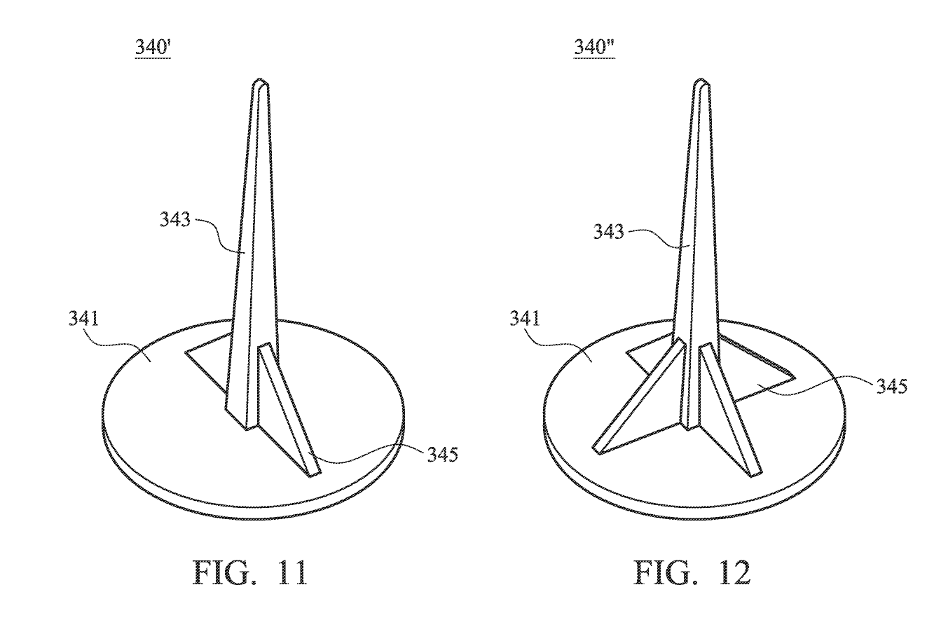

Referring to FIGS. 11 and 12, to increase the mechanical strength of the polygonal support member 340′ in order to support the optical film 20 (FIG. 2), a plurality of reinforcing structures 345 may be connected between the base 341 and the main body 343. For example, the polygonal support member 340′, shown in FIG. 11, includes two reinforcing structures 345 with a triangular shape connected between two opposite sides of the main body 343 and the base 341. In another example, the polygonal support member 340″, as shown in FIG. 12, includes four reinforcing structures 345 with a triangular shape connected between four sides of the main body 343 and the base 341.

As shown in FIG. 9, the partition 350 is disposed on the substrate 310 along the dividing line M, wherein the polygonal support member 340 is located between the two partitions 350. In the embodiment, the transverse section of the partition 350 includes a combination of a semi-elliptically shape and rectangular shape, wherein the transverse section is perpendicular to the lower surface 315. The partition 350 has a second height H₆ extending along the direction V away from the substrate 310, wherein the second height H₆ is less than half the first height H₅.

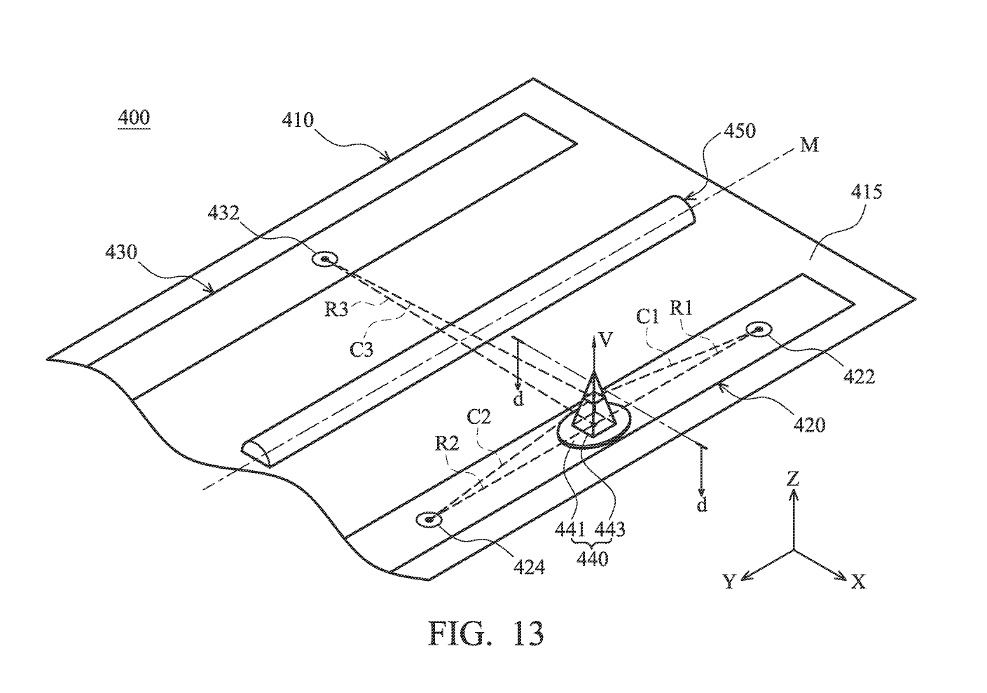

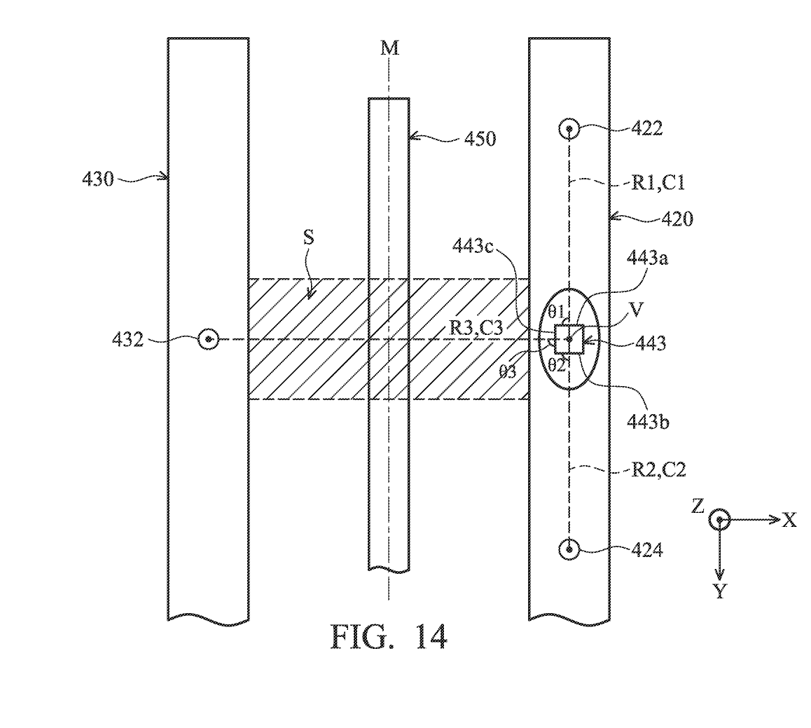

FIG. 13 shows a schematic view of elements of the backlight module 400 in accordance with a fourth embodiment of the present disclosure, and FIG. 14 shows a cross-sectional view taken along line d-d in FIG. 13, as seen from the extending direction V. The backlight module 400 includes a substrate 410, a first light bar 420, a second light bar 430, at least one polygonal support member 440, and a partition 450. Relative to the two sides of the dividing line M, the first and second light bars 420 and 430 are disposed on the lower surface 415 of the substrate 410. The first light bar 420 includes a first light source 422 and a second light source 424 arranged thereon, and the second light bar 430 includes a third light source 432 disposed thereon.

The polygonal support member 440 is fabricated by a light-transmitting material. In one exemplary embodiment, the polygonal support member 440 is made of PMMA, but it is not limited thereto. Any light-transmitting material can be applied as the polygonal support member 440 of the present disclosure. The polygonal support member 440 includes a base 441 and a main body 443. The bottom surface of the base 441 is located on the first light bar 420 centered between the first light source 422 and the second light source 424, but it should not be limited thereto. The base 441 may be closer to the first light source 422 or the second light source 424. The main body 443 is disposed on the base 441 and extends along the direction V away from the substrate 410, wherein along the direction V, the area of transverse sections of the polygonal support member 440 decreases gradually.

As shown in FIG. 14, the main body 443 has a first side 443a, a second side 443b, and a third side 443c on one of its transverse sections, wherein the transverse section is parallel to the lower surface 415. The first side 443a is at one of the lateral surfaces which is most adjacent to the first light source 422. An angle θ1 formed by a projection line R1 of a connecting line C1 between the midpoint of the first side 443a and the first light source 422 and a projection line of the first side 443a on the lower surface 415 is between 80 degrees and 100 degrees. The second side 443b is at one of the lateral surfaces which is most adjacent to the second light source 424. An angle θ2 formed by a projection line R2 of a connecting line C2 between the midpoint of the second side 443b and the second light source 424 and a projection line of the second side 443b on the lower surface 415 is between 80 degrees and 100 degrees. The third side 443c is at one of the lateral surfaces which is most adjacent to the third light source 432. An angle θ3 formed by a projection line R3 of a connecting line C3 between the midpoint of the third side 443c and the third light source 432 and a projection line of the third side 443c on the lower surface 415 is between 80 degrees and 100 degrees.

With the structural features of the main body 443, light from the first light source 422, the second light source 424, and the third light source 432 that may be complete reflected by the first side 443a, the second side 443b, or the third side 443c of the main body 443 is further reduced. Thus, the shadow noises produced around the polygonal support member 440 can be eliminated. It is noted that, while the angles θ1, θ2, and θ3 are between 80 degrees and 100 degrees, they should not be limited thereto. With the angles θ1, θ2, and θ3 being substantially formed at or near to a right angle, the possibility of total reflection decreases. Preferably, the angles θ1, θ2, and θ3 are between 85 degrees and 95 degrees, while other angles may be implemented to prevent light from being completely reflected on the light-emitting surface of the polygonal support member 440.

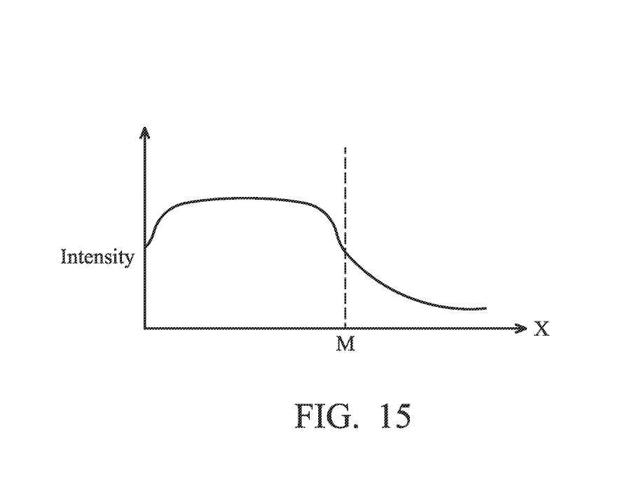

The partition 450 is along the dividing line M disposed on the substrate 410. In the embodiment, the transverse section of the partition 450 has a semi-circular shape, wherein the transverse section is perpendicular to the lower surface 415 of the substrate 410. FIG. 15 shows a curve diagram showing variation in the intensity of fluorescent energy of the third light source 432 in a region S in FIG. 14 with respect to an increase in the distance along the X direction. Due to the shield of the partition 450, the intensity of fluorescent energy of the third light source 432 is obviously decreased once the light from the third light source 432 passes through the dividing line M. Thus, the light leakage issue is resolved, and the display quality of the display device 1 (FIG. 2) with the backlight module 400 is further enhanced.

Because each of the lateral sides of the support member facing the light sources is a flat plane, light from the light sources is able to pass through the support member without hindrance. Thus, the image display quality of the display device is improved due to a reduction of shadow noises produced around the support member.

While the invention has been described by way of example and in terms of preferred embodiment, it is to be understood that the invention is not limited thereto. On the contrary, it is intended to cover various modifications and similar arrangements (as would be apparent to those skilled in the art). Therefore, the scope of the appended claims should be accorded the broadest interpretation so as to encompass all such modifications and similar arrangements.

What is claimed is:

1. A backlight module, comprising:
a substrate having a lower surface;
a light source disposed on the substrate; and
at least one polygonal support member, wherein a transverse section of the polygonal support member includes a first side, and an angle formed by a projection line of a connecting line between the midpoint of the first side and the light source on the lower surface and a projection line of the first side on the lower surface is between 80 degrees and 100 degrees.

2. The backlight module as claimed in claim 1, wherein the number of light sources is greater than one, and the transverse section of the polygonal support member further includes a second side, wherein the first side is located at one of the lateral surfaces of the polygonal support member that is mostly adjacent to the first light source, and the second side is located at one of the lateral surfaces of the polygonal support member that is mostly adjacent to a second light source, and wherein an angle formed by a projection line of a connecting line between the midpoint of the second side and the second light source on the lower surface and a projection line of the second side on the lower surface is between 80 degrees and 100 degrees.

3. The backlight module as claimed in claim 2, wherein the bottom surface of the polygonal support member is located on the connecting line between the first and second light sources.

4. The backlight module as claimed in claim 2, wherein the polygonal support member further comprises a third side, and the third side is located at one of the lateral surfaces of the polygonal support member that is mostly adjacent to a third light source, and wherein an angle formed by a projection line of a connecting line between the midpoint of the third side and the third light source on the lower surface and a projection line of the third side on the lower surface is between 80 degrees and 100 degrees.

5. The backlight module as claimed in claim 4, wherein the polygonal support member further comprises a fourth side, and the third side is located at one of the lateral surfaces of the polygonal support member that is mostly adjacent to a fourth light source, and wherein an angle formed by a projection line of a connecting line between the midpoint of the fourth side and the fourth light source on the lower surface and a projection line of the fourth side on the lower surface is between 80 degrees and 100 degrees.

6. The backlight module as claimed in claim 5, wherein at least a portion of the bottom surface of the polygonal support member is located within on a region surrounded by the connecting lines between the light sources.

7. The backlight module as claimed in claim 2, further comprising:
a first light bar and a second light bar, disposed on the substrate, wherein the light sources are disposed on each of the first light bar and the second light bar; and
a partition, disposed between the first light bar and the second light bar.

8. The backlight module as claimed in claim 7, wherein the transverse section of the polygonal support member is polygonal, semi-circular shaped, semi-elliptically shaped or any combination of these shapes.

9. The backlight module as claimed in claim 7, wherein the polygonal support member has a first height extending along a direction away from the substrate, and the partition has a second height extending along a direction away from the substrate, wherein the second height is less than half the first height.

10. A display device, comprising:
a backlight module, comprising:
a substrate, having a lower surface;
a plurality of light sources, disposed on the substrate; and
at least one polygonal support member, wherein a transverse section of the polygonal support member includes a first side, and an angle formed by a projection line of a connecting line between the midpoint of the first side and the light source on the lower surface and a projection line of the first side on the lower surface is between 80 degrees and 100 degrees; and
a display panel, disposed upon the backlight module.

11. The display device as claimed in claim 10, wherein at least a portion of the bottom surface of the polygonal support member is located on a region surrounded by the connecting lines between the light sources.

12. The display device as claimed in claim 10, further comprising an optical film disposed between the display panel and the backlight module, wherein the optical film is disposed on the polygonal support member, and the height of the polygonal support member is equal to the distance between the optical film and the substrate.

13. The display device as claimed in claim 10, further comprising:
a first light bar and a second light bar, disposed on the substrate, wherein the light sources are disposed on each of the first light bar and the second light bar; and
a partition, disposed between the first light bar and the second light bar.

14. The display device as claimed in claim 13, wherein the polygonal support member has a first height extending along a direction away from the substrate, and the partition has a second height extending along a direction away from the substrate, wherein the second height is less than half the first height.

15. The display device as claimed in claim 13, wherein the transverse section of the polygonal support member is polygonal, semi-circular shaped, semi-elliptically shaped or any combination of these shapes.
